(19) United States
(12) Patent Application Publication
(10) Pub. No.: US 2025/0308279 A1
(43) Pub. Date: Oct. 2, 2025

(54) METHOD AND APPARATUS TO RETRIEVE OBSCURED FORM INFORMATION

(71) Applicant: KONICA MINOLTA BUSINESS SOLUTIONS U.S.A., INC., Foster City, CA (US)

(72) Inventor: Ting XU, Campbell, CA (US)

(21) Appl. No.: 18/622,758

(22) Filed: Mar. 29, 2024

(51) Int. Cl. G06V 30/418; G06V 30/412; H04N 1/387

(52) U.S. Cl. CPC G06V 30/418; G06V 30/412; H04N 1/3878

(57) ABSTRACT

Aspects of the present invention enable matching of bank account information and payee information from invoices and other billing documents, in situations in which some or all of the payee information is obscured, blurred, or otherwise illegible. In an embodiment, a payee dictionary, which may comprise a hashmap, may be accessed with a key prepared from data taken from an invoice or other billing document, where some of the relevant data in the document is unavailable because of an overlying stamp or seal. Where the key is either incorrect or insufficient, a user may review the key data and match it with the appropriate payee dictionary contents, to update or correct the dictionary.

### BACKGROUND OF THE INVENTION

In a number of countries in Asia and elsewhere in the world, companies place a corporate seal or other private or unique seal on documents to indicate official company acceptance or acknowledgement of the documents. Often, the seal can overlie text on a document, making the text difficult to decipher. It is not always practicable to remove the seal or stamp from the document, depending on the nature of the stamp and the underlying text. Removal can be particularly challenging when the underlying text and the stamp are the same color or hue (e.g. grayscale).

In the case of invoices or similar finance-related forms, stamps can cover up certain textual information such as name, address, telephone, facsimile, and/or email information for the company to be paid (the payee, who normally is the issuer of the invoice).

It would be useful to be able to determine information underneath stamps accurately, without regard to stamp color and text color, so as to be able to match up the necessary information to route payments accurately.

### SUMMARY OF THE INVENTION

Aspects of the invention combine deep learning with manual correction to ensure accurate routing of payments. Text recovery may be treated as an information retrieval problem, thereby improving accuracy. In one aspect, manual correction of a database of bank account, bank branch, and payee information can enable expansion or enlargement of the database, and/or of a dictionary that matches payees with their correct bank account information. The database or dictionary also can be enhanced through adding information relating to the payee.

Embodiments of the invention provide a computer-implemented method which may comprise:
a) responsive to receipt of an input scanned financial document, identifying one or more text and/or data fields in the scanned financial document, the one or more text and/or data fields containing company and/or financial information;
b) responsive to identification of one or more text and/or data fields containing desired financial information, constructing a key comprising concatenated company and/or financial information from the identified one or more text and/or data fields;
c) wherein at least one of the identified one or more text and/or data fields has at least some of its information obscured or otherwise illegible or undecipherable, and wherein the constructing comprises using the company and/or financial information that is not obscured or is otherwise legible or decipherable;
d) using the constructed key to access a dictionary of company information; and
e) responsive to a match between at least one record in the dictionary and the constructed key, extracting and displaying the record, and matching information in the record to the company and/or financial information in the scanned financial document.

In some embodiments, the method further may comprise:
f) responsive to no match between at least one record in the dictionary and the constructed key, using the constructed key to correct or add one or more entries to the dictionary; and
g) repeating e).

In some embodiments, the method further may comprise:
h) repeating f) and g) until e) produces a match.

In some embodiments, the key may comprise information about a bank with which the company has one or more accounts, the information including at least a bank account number.

In some embodiments, the dictionary of company information may contain bank address information and/or bank branch address information with which to match up the bank account number.

In some embodiments, the method may further comprise correcting the scanned financial document before a), the correcting including orienting and/or deskewing one or more pages of the financial document.

In some embodiments, the correction may be carried out manually.

In some embodiments, the correction may be carried out using a machine learning system.

In some embodiments, the information about the company may include company name and address information, and contact information.

In some embodiments, the contact information may include a telephone and/or facsimile number, or one or more email addresses.

Embodiments of the invention provide an apparatus for performing the just-listed method.

### BRIEF DESCRIPTION OF THE DRAWINGS

Aspects of the present invention now will be described in detail with reference to embodiments, in conjunction with the accompanying drawings, in which:

FIGS. 1A-1C are examples of categories of stamps;

FIGS. 2A-2L are examples of different kinds of stamps under different kinds of conditions;

FIGS. 3A and 3D show examples of text underneath a stamp;

FIG. 4 is a high level flow chart according to some embodiments;

FIG. 5 is a high level block diagram according to some embodiments;

FIG. 6 is a high level block diagram of portions of FIG. 5 according to an embodiment.

### DETAILED DESCRIPTION

As ordinarily skilled artisans will appreciate from the following description, there may be a number of advantages to the approach to be described with respect to embodiments of the present invention:
Identification and extraction of correct company information even when some of the text is substantially completely obscured;
Higher extraction accuracy than computer vision based methods;
No need to model seal or stamp detection, or seal or stamp classification, or to recognize characters within seals or stamps;

Relieving an optical character recognition (OCR) engine from having to recognize text such as company names in what may be uncommon or artistic or simply difficult to decipher fonts;

Multiple keys available to retrieve bank transfer information. For example, a telephone number or fax number could be used as a secondary key when bank information itself is not available;

Greater robustness of search method with higher likelihood of success where ambiguities may exist, for example, where there may be multiple bank branches;

Availability of a database of payee and bank information as a verification source;

The connected component analysis (CCA) aspect of embodiments, enabling analysis of connected pixels in an image, is considerably different and, in the present situation, more straightforward than Independent Component Analysis (ICA), which requires separate treatment of pixels and thereby requires an assumption of non-Gaussian source data distribution.

Before going into embodiments and details of aspects of the present invention, it may be helpful to look at the kinds of issues that stamped financial documents present.

Invoices are a type of document that typically come from the entity to be paid (the payee), and present a charge for some purchase. Often a fair amount of information about the payee—not only name, but also address and/or telephone/fax numbers may be included. However, some or most of this information often may be occluded or damaged by a corporate seal. Recognizing, let alone understanding the affected text can be very challenging.

In many instances the invoice also may include how the payee can be paid. For example, there may be bank account information on the invoice, including account number, bank name, sometimes bank branch, and bank branch address and telephone/fax numbers for the bank/branch. According to an embodiment, this information may be used in conjunction with the dictionary which will be discussed in more detail herein, to enable matching of bank account number and payee.

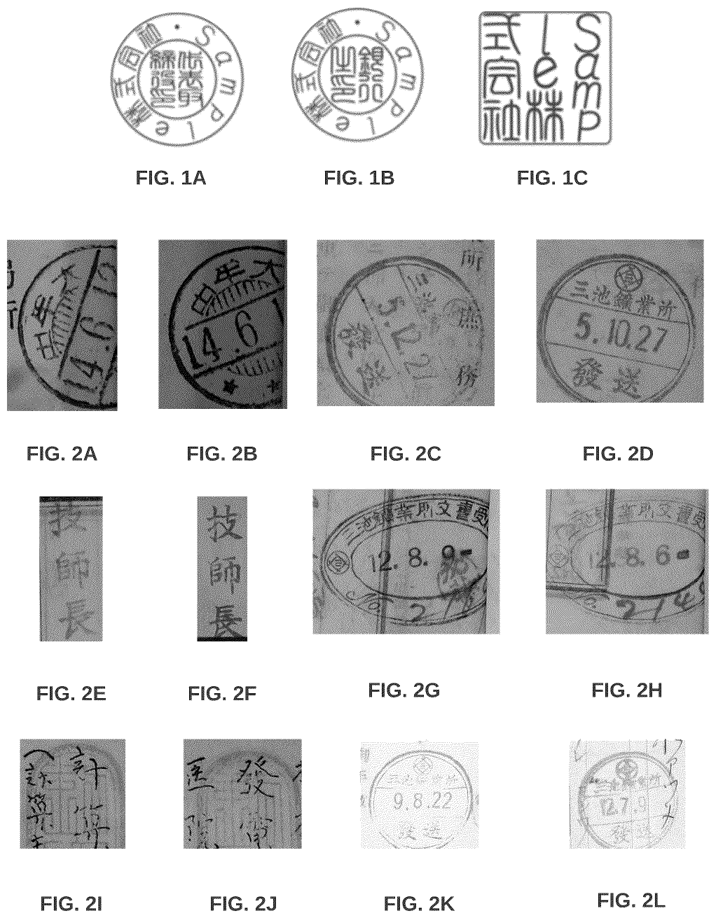

Looking at the stamps themselves, there may be different types. For example, FIG. 1A is a sample of a corporate seal, FIG. 1B is a sample of a banking seal, and FIG. 1C is a sample of an identification seal (Source: https://ventureinq.com/corporate-seal/). Different seals can be placed over the same section and/or text of an invoice, for example, even though the seals can serve different purposes and can connote different things.

Seal detection can be very challenging for a number of reasons. For example, seals can vary widely in a number of characteristics, such as seal appearance; amount and color of ink applied; pressure with which a seal is applied; seal size; scanning quality (skew, orientation, resolution, blurring); and text interference with the seal, a variance which aspects of the present invention attempt to address. Some of the interference with the underlying text can come from text in the seal itself.

FIGS. 2A-2L show examples of different seals embodying one or more of these interference characteristics. (Source: MiikeMineStamps Dataset, available at https://kilthub.cmu.edu/articles/dataset/MiikeMineStamps_Dataset/14604768).

For ease of comparison, different images of the same stamp from the above-mentioned dataset have been placed in pairs and labeled consecutively in FIGS. 2A-2L to provide a range of examples which aspects of the present invention need to address. In each of the pairs FIGS. 2A-2B; 2C-2D; 2E-2F; 2G-2H; 21-2J; and 2K-2L, one of the stamps is darker than (applied with more pressure and/or with more ink) and/or at a different skew angle than the other in the pair. Different ones of these stamps interfere to a greater or lesser degree with underlying text.

FIGS. 2A-2L contain a few different examples of seals. There are many, many companies who have their own seals, including variations of seals. As a result, it can be very difficult to identify correctly the company to which a seal belongs. The wide variability in seal design and appearance also makes it all but impossible to obtain enough training samples for each company's seals to train a seal classification model sufficiently. It also could be the case that all of the pages of a financial document are stamped, or that fewer than all of them are stamped. In some cases, seals may not be present at all, or if they are, they do not overlie text. Sometimes the seal itself is damaged or obscured, or otherwise defective, as several of the samples in FIGS. 2A-2L reflect. Seal damage can be difficult to simulate, making it difficult to have the amount and kind of information necessary to train/retrain or fine tune an OCR engine to make it sufficiently resistant to seal damage. Where the seal and the underlying text are the same or similar colors, or at least both in grayscale, resolution also can be difficult.

While the discussion thus far has focused on the types of stamps that can obscure text, aspects of the invention relate to correct identification of a payee on an invoice, and matchup of the identified payee with the correct bank information to which a payor can remit funds to pay the payee, without having to rely on stamp removal from the invoice.

The stamps discussed above can be placed over payee information or over payee bank information on an invoice. While there are techniques for removing stamp data from invoices, it can be advantageous (and more accurate) not to have to rely on technique, a number of which can involve some kind of deep learning technique, to retrieve payee and payee bank information from an invoice. Deep learning techniques obviously have their advantages, as ordinarily skilled artisans can appreciate. But accuracy can suffer, because the amount of training possible for a deep learning system, given the kinds of data involved with stamps and seals and the text underlying the stamps and seals.

Among various aspects of the present invention, there are some primary constituent parts. A first part is a dictionary or concordance which maps bank information to payee information. Payee information is the kind of information that stamps on invoices can obscure. Bank information, which normally is not obscured on the invoice, can be used to retrieve payee information (company name, address, bank account information, and the like) to match up account holders and accounts. Bank information may include, but need not be limited to bank name, bank branch name, bank branch address, telephone and/or facsimile numbers, email addresses, names of contact people or people in charge, and the like. Dictionary creation can occur in a number of ways that ordinarily skilled artisans will appreciate. Refining, editing, and/or augmenting the payee dictionary is one goal of aspects of the present invention.

A second constituent part is the ability to extract bank payment information from an invoice, and to provide a search key for the just-mentioned payee dictionary/concordance. Successful searching of the payee dictionary, using search keys containing relatively limited data, is another goal of aspects of the present invention.

In an embodiment, it may be possible to select and correctly identify payee information in an invoice based on the payee dictionary contents and prefilled payee company information which a user can verify and, if necessary, correct.

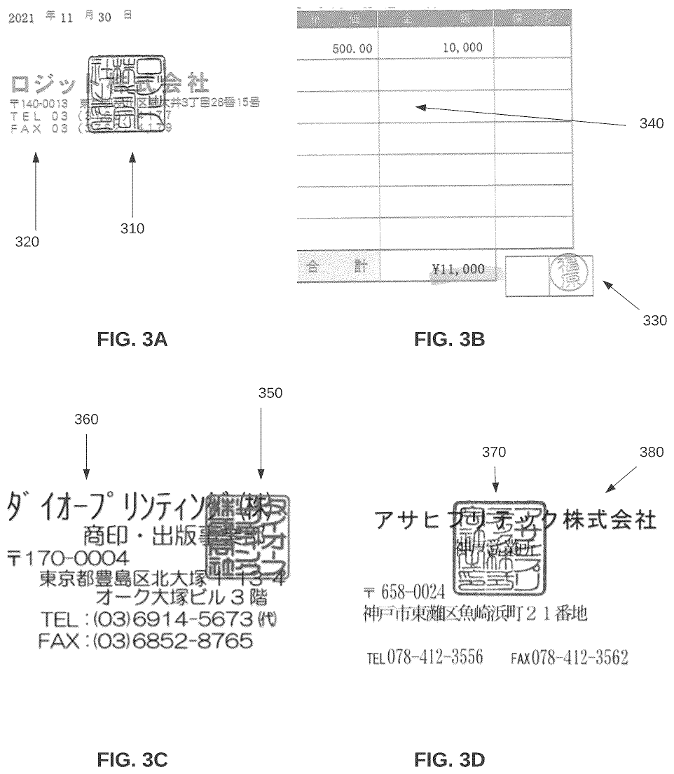

FIGS. 3A-3D show different examples of stamps or seals and attendant documents. In FIG. 3A, which shows a portion of a form, a stamp 310 overlies text 320. There are some unobscured portions of text 310 on either side of the stamp. It is possible that some of these unobscured portions may be useful in extracting correct payee and/or payee bank information from the form.

FIG. 3B presents a situation which does not impede information identification, because stamp or seal 330 does not overlie or obscure any text. FIG. 3C shows a stamp 350 which overlies text 360, but which leaves telephone and facsimile information, as well as some possibly significant fragments of company and/or bank information uncovered. Aspects of the present invention can use secondary information such as phone and fax numbers to match up payees with payee account information. FIG. 3D presents a situation similar to that of FIG. 3C, as a stamp 370-overlies text 380 but leaves possibly significant portions of the text, including telephone and facsimile information, uncovered.

With reference to FIGS. 3A, 3C, and 3D in particular, some discussion of use of unobscured information such as bank or payment information to derive payee name and address and contact information may be helpful.

Many pieces of data such as organization name, company name, date, or money amount can be searched because such data exhibit some kind of pattern. The pattern could be in a keyword, or in content, or both. For example, a Japanese bank name typically may end with the characters “ [symbol] ” (bank). A Japanese bank branch name typically may end with the characters “ [symbol] ” (branch). Even without preceding keywords such as “ [symbol] ” (transfer bank name) or “ [symbol] ” (financial institution name), it still may be possible to extract the bank name. According to different embodiments, there may be search rules provided to enable extraction of information such as address, telephone/facsimile number (as in FIGS. 3C and 3D, for example), company name, and the like. Taking into account the locations of data in the document, and in some cases, signal words such as “ [symbol] ” (thank you) or “ [symbol] (Mr.)”, which imply certain kinds of information in the data locations, some data may be differentiated as pertaining to the payor rather than to the payee. In this fashion, it can be possible to discriminate payor and payee information, and ignore or discard the payor information in favor of the payee information. Then, the identified and extracted bank information (bank name, branch name, branch address, telephone number, account type, account number, account holder, and the like) may be constructed into a key for the payee company dictionary, and associated appropriately with the payee.

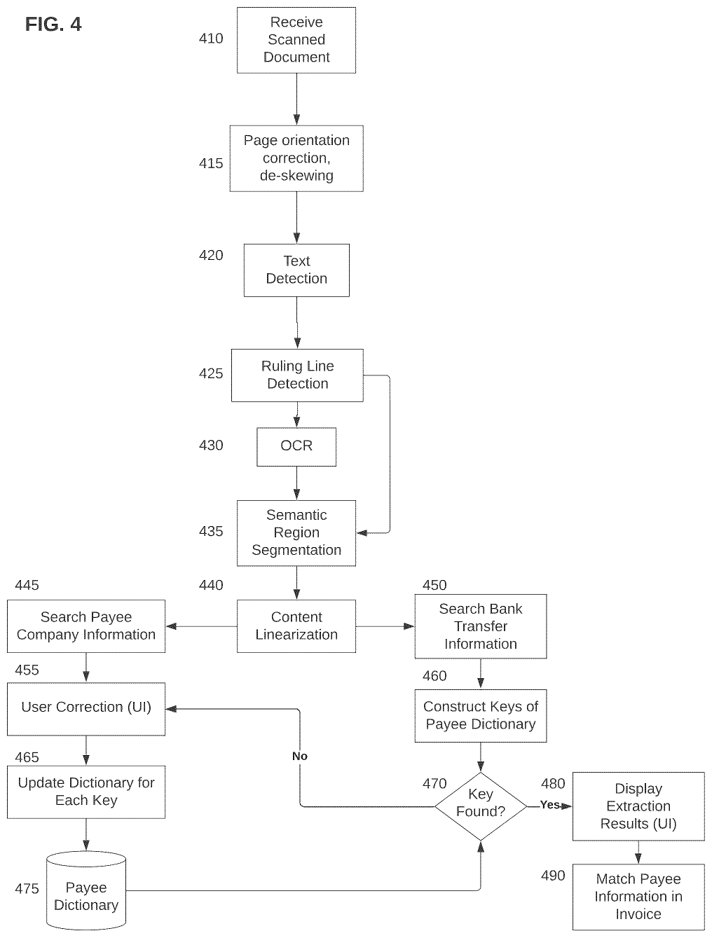

FIG. 4 is a high level flow chart depicting operation of embodiments of the present invention. Initially, a scanned document may be set up for information retrieval. To set up the document appropriately, first, at 410 a scanned document is received. At 415, pages of the document are oriented so as to be upright (at 90 degrees; other orientations can be multiples of 90 degrees). Data on the page may be corrected and/or de-skewed as necessary, depending on the quality of the scanned input. Depending on the embodiment, correction may include re-sizing, denoising, or the like. At 420, presence of text in the document may be detected. At 425, any lines denoting table borders, ruling lines, or other segmentation or separation of text on the page may be detected. Image binarization and connected component analysis (CCA) may be used to generate bounding boxes for text. In an embodiment, graphical objects such as logos and barcodes typically would not be considered relevant and so would not be detected.

After generation of bounding boxes comes character recognition of the detected text. In an embodiment, at 430, optical character recognition (OCR) may be performed to identify text specifically. In an embodiment, the ruling line detection may be handled by a neural network model such as a semantic segmentation model (435) which can classify image pixels into text related pixels and ruling line related pixels. Using ruling lines on the document page, and the text bounding boxes, it is possible to segment a document page into one or more regions, wherein each of the regions contains related text. Deep learning techniques can be applied to recognize regions of related text as being relevant or not relevant. For example, relevant payee information of the type discussed previously may appear in certain areas of invoices. Of course, different invoices may contain payee information in different areas. Deep learning techniques are well suited to identifying the appropriate areas.

In an embodiment, after text/data is identified appropriately in one or more regions, the text or data may be grouped appropriately if necessary, for example, as a table, or as a header, or as a paragraph, if necessary. Whether there is a single region containing such information or multiple regions, once any necessary grouping has been completed, formatting of the text/data can be removed, as at 440, in a process referred to content linearization, to provide a text stream with associated keywords and content. In an embodiment, the keywords and content may be concatenated. Then, searches can be carried out using expressions designed specifically to facilitate searching in a desired field, for example, for bank information. The concatenated data may be used as a key to access a payee dictionary, as will be described.

FIG. 4 shows two paths after content linearization is completed. The left hand path, beginning at 445, contributes to construction of or addition to a dictionary of payee company information (company name and address, contact information, and the like). At 455, a user may make any necessary corrections or additions via a user interface (UI). At 465, the dictionary information may be updated for each key requiring correction or addition to the dictionary. At 475, the updates are stored in a payee dictionary. The updated payee dictionary then is used on the right hand path after content linearization of payee data from invoices.

The right hand path, beginning at 450, is the path in which searches to the payee dictionary are carried out using keys made of the concatenated information. Looking more closely at the right hand path, at 450, payee bank transfer information is searched for in the keywords and content resulting from the content linearization at 440. In an embodiment, at 460, payee keys may be constructed from the content to search the payee dictionary. In an embodiment, to facilitate extraction of information from a Japanese invoice, for example, the payee dictionary may take the form of a hashmap that maps bank transfer information (for example, ( [symbol] ) (payee)) to a payee company object.

Depending on the embodiment, bank transfer information typically may include the name of the destination bank, the bank branch name, the bank account type, the bank account number, and sometimes (but not always) the bank account holder name. Because the account holder name is not always present, in an embodiment that name may not be used as a hashmap key. In an embodiment, the hashmap key may be a string formed by concatenating the bank name (stripping the word “ [symbol] ” (bank) from the name), the branch name (stripping the word “ [symbol] ” (branch) from the name), a bank account type (which may be a single character such as [symbol] (current) or [symbol] (common)), and a bank account number (a sequence of digits), sometimes including a separator character such as an underscore.

In an embodiment, the constructed key for the payee company may be used to query the dictionary. At 470, If a match exists for the constructed key, then at 480 the corresponding company information can be directly output to the UI. Otherwise, flow goes to the left hand path at 455 for user correction, and then to 465 for dictionary updates to include the user correction with the payee information, and then to 475 for addition of the payee information to the payee dictionary for each bank transfer destination key.

After the first iteration of user correction, it may be expected that there will be a match between the constructed key(s) and the payee dictionary contents, since the user made any necessary corrections to include the key(s) in the dictionary. If there is no match, flow would return to 455 for further correction. If there is a match, at 450 the dictionary contents for the payee would be extracted from the payee dictionary, and payee information from the dictionary will be matched with the payee information in the invoice.

In an embodiment, aspects of the present invention permit user correction of key information. For example, a stamp or seal may cover company information, so that matching bank information with the company information may not produce a match with a previously created and stored key. In such a circumstance, user correction and dictionary updates at 455-475 can remedy the situation.

On relatively rare occasion, invoices may provide payee company information, but not payee bank information. Matching the invoice with the appropriate payee bank account can be more challenging in such circumstances. In an embodiment, secondary information such as a telephone number may be matched up with a company address. The resulting combination may enable identification of the correct telephone number in the dictionary, and then a match with the bank account information in the dictionary. This combination presents a different situation from one in which an identified bank account number may be used to identify the company. Relying on secondary information can result in a more complicated embodiment, but could still provide a path to using other non-obscured information on an invoice to access information in the dictionary to retrieve the data necessary to match up the payee company information and payee bank account information.

Aspects of the invention can address situations with OCR errors in which the OCR output may include incorrect account number information. In the case of trying to match a bank account number and a bank account holder name, because of the sheer number of possible variants in account numbers, and sometimes in account holders (for example, different offices of the same company, where the different offices have their own accounts), an OCR error will be more likely to generate the kind of key error that would require user intervention, rather than would identify an incorrect bank account to which to send funds.

One or more embodiments of the present invention apply user intervention rather than some variety of machine learning system to update the payee dictionary when there is no match between the key (retrieved information from the document) and the payee dictionary contents. The user-involved approach avoids guesses and possible errors from the machine learning system, and enables accuracy more closely approaching 100%. When trying to match payees and their bank account information, mistakes can be expensive.

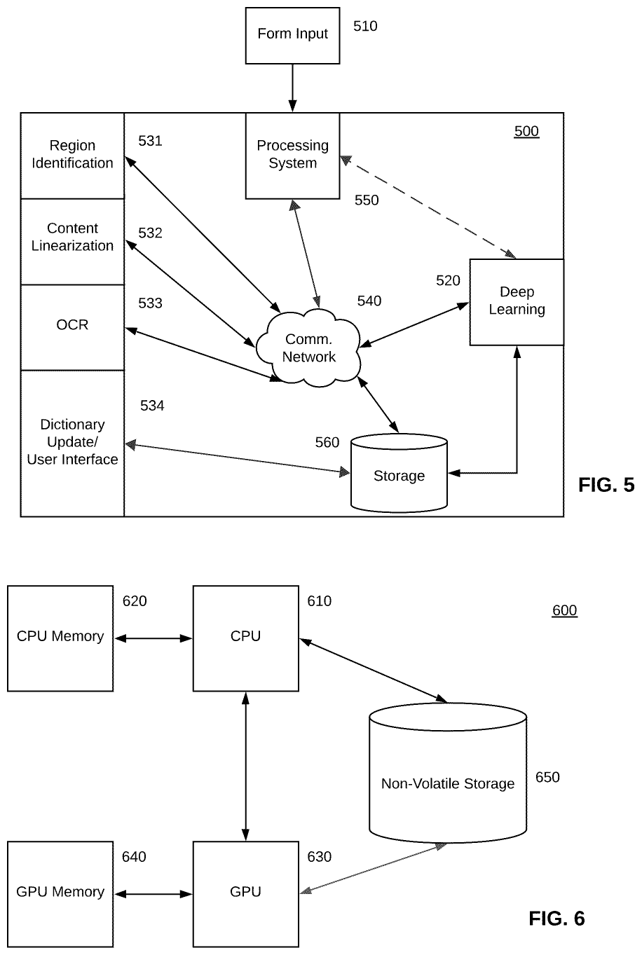

FIG. 5 is a high level block diagram of a computing system 500 which may implement a deep learning system 520, trained on known data as discussed above. Depending on the embodiment, form input 510 may take forms from any number of sources, including not only “live” sources such as scanners, cameras, or other imaging equipment which can provide images of known text sequences, but also “canned” sources such as libraries. In an embodiment, “live” sources as part of form input 510 also may handle text to be processed for electronic documents.

Processing system 550 may be a separate system, or it may be part of form input 510, or may be part of deep learning system 520, depending on the embodiment. Processing system 550 may include one or more processors, one or more storage devices, and one or more solid-state memory systems (which are different from the storage devices, and which may include both non-transitory and transitory memory).

In an embodiment, processing system 550 may include deep learning system 520 or may work with deep learning system 520 to facilitate region identification in block 531, or content localization in block 532, or OCR operation in block 533 in accordance with the various stages discussed above with respect to FIG. 4. In some embodiments, one or more of region identification in block 531, or content localization in block 532, or OCR operation in block 533 may implement its own deep learning system 520. In accordance with an embodiment, dictionary update/user interface block 534 does not employ machine learning. In embodiments, each of blocks 531, 532, 533, or 534 may include one or more processors, one or more storage devices, and one or more solid-state memory systems (which are different from the storage devices, and which may include both non-transitory and transitory memory). In embodiments, additional storage 560 may be accessible to one or more of blocks 531, 532, 533, or 534, and to processing system 550 over a communications network 540, which may be a wired or a wireless network or, in an embodiment, the cloud.

In an embodiment, storage 560 may contain training data for the one or more deep learning systems in one or more of blocks 520, 531, 532, 533, or 550. Storage 560 may store forms from form input 510, and/or OCR information from OCR block 533.

Where communications network 540 is a cloud system for communication, one or more portions of computing system 500 may be remote from other portions. In an embodiment, even where the various elements are co-located, network 540 may be cloud-based.

FIG. 6 is a high level diagram of apparatus 600 which may be used as one or more of the blocks 520, 531-534, and 550 according to embodiments. In FIG. 6, one or more CPUs 610 may communicate with CPU memory 620 and non-volatile storage 650. One or more GPUs 630 may communicate with GPU memory 640 and non-volatile storage 650. Generally speaking, a CPU may be understood to have a certain number of cores, each with a certain capability and capacity. A GPU may be understood to have a larger number of cores, in many cases a substantially larger number of cores than a CPU. In an embodiment, each of the GPU cores may have a lower capability and capacity than that of the CPU cores, but may perform specialized functions in the deep learning system, enabling the system to operate more quickly than if CPU cores were being used.

In describing embodiments of the invention, the foregoing mentions invoices to provide context for payee information to be retrieved from the invoices and matched with payee account information. There may be embodiments in which some documents have sufficiently similar characteristics to forms that the techniques of the invention may be applicable to such documents. For example, there are varieties of financial documents, legal documents, official government documents, and official notifications that can bear seals which obscure texts of some entity names such as the document issuer. With such documents, aspects of the present invention can search unobscured but correlated pieces of information to ascertain the obscured information. It should be noted that obscured text may be stamped because it is acceptable for them to be illegible, as the reader of the documents should already know that information.

While the foregoing describes embodiments according to aspects of the invention, the invention is not to be considered as limited to those embodiments or aspects. Ordinarily skilled artisans will appreciate variants of the invention within the scope and spirit of the appended claims.

What is claimed is:

1. A computer-implemented method comprising:
a) responsive to receipt of an input scanned financial document, identifying one or more text and/or data fields in the scanned financial document, the one or more text and/or data fields containing company and/or financial information;
b) responsive to identification of one or more text and/or data fields containing desired financial information, constructing a key comprising concatenated company and/or financial information from the identified one or more text and/or data fields;
c) wherein at least one of the identified one or more text and/or data fields has at least some of its information obscured or otherwise illegible or undecipherable, and wherein the constructing comprises using the company and/or financial information that is not obscured or is otherwise legible or decipherable;
d) using the constructed key to access a dictionary of company information; and
e) responsive to a match between at least one record in the dictionary and the constructed key, extracting and displaying the record, and matching information in the record to the company and/or financial information in the scanned financial document.

2. The method of claim 1, further comprising:
f) responsive to no match between at least one record in the dictionary and the constructed key, using the constructed key to correct or add one or more entries to the dictionary; and
g) repeating e).

3. The method of claim 2, further comprising:
h) repeating f) and g) until e) produces a match.

4. The method of claim 1, wherein the key comprises information about a bank with which the company has one or more accounts, the information including at least a bank account number.

5. The method of claim 4, wherein the dictionary of company information contains bank address information and/or bank branch address information with which to match up the bank account number.

6. The method of claim 1, further comprising correcting the scanned financial document before a), the correcting including orienting and/or deskewing one or more pages of the financial document.

7. The method of claim 2, wherein correction is carried out manually.

8. The method of claim 2, wherein correction is carried out using a machine learning system.

9. The method of claim 1, wherein the information about the company comprises company name and address information, and contact information.

10. The method of claim 9, wherein the contact information comprises a telephone and/or facsimile number, or one or more email addresses.

11. A system comprising:
a processor; and
non-volatile memory connected to said processor, said non-volatile memory containing instructions which, when the processor executes them, perform the following method:
a) responsive to receipt of an input scanned financial document, identifying one or more text and/or data fields in the scanned financial document, the one or more text and/or data fields containing company and/or financial information;
b) responsive to identification of one or more text and/or data fields containing desired financial information, constructing a key comprising concatenated company and/or financial information from the identified one or more text and/or data fields;
c) wherein at least one of the identified one or more text and/or data fields has at least some of its information obscured or otherwise illegible or undecipherable, and wherein the constructing comprises using the company and/or financial information that is not obscured or is otherwise legible or decipherable;
d) using the constructed key to access a dictionary of company information; and
e) responsive to a match between at least one record in the dictionary and the constructed key, extracting and displaying the record, and matching information in the record to the company and/or financial information in the scanned financial document.

12. The apparatus of claim 11, wherein the method further comprises:
f) responsive to no match between at least one record in the dictionary and the constructed key, using the constructed key to correct or add one or more entries to the dictionary; and
g) repeating e).

13. The apparatus of claim 11, wherein the method further comprises:
h) repeating f) and g) until e) produces a match.

14. The apparatus of claim 11, wherein the constructed key comprises information about a bank with which the company has one or more accounts, the information including at least a bank account number.

15. The apparatus of claim 14, wherein the dictionary of company information contains bank address information and/or bank branch address information with which to match up the bank account number.

16. The apparatus of claim 11, correcting the scanned financial document before a), the correcting including orienting and/or deskewing one or more pages of the financial document.

17. The apparatus of claim 12, wherein correction is carried out manually.

18. The apparatus of claim 12, wherein correction is carried out using a machine learning system.

19. The apparatus of claim 11, wherein the information about the company comprises company name and address information, and contact information.

20. The apparatus of claim 19, wherein the contact information comprises a telephone and/or facsimile number, or one or more email addresses.
